(19) United States
(12) Patent Application Publication
(10) Pub. No.: US 2023/0138429 A1
(43) Pub. Date: May 4, 2023

(54) OPTICAL APPARATUS, IN-VEHICLE SYSTEM, AND MOVING APPARATUS

(71) Applicant: CANON KABUSHIKI KAISHA, Tokyo (JP)

(72) Inventor: Tomoaki Kawakami, Tochigi (JP)

(21) Appl. No.: 17/965,940

(22) Filed: Oct. 14, 2022

(30) Foreign Application Priority Data
Oct. 28, 2021 (JP) 2021-176063

(51) Int. Cl. G02B 19/00; G02B 26/08; G02B 27/30; G02B 27/12; G02B 26/10; B60T 7/22; B60Q 9/00; G01S 17/931; G01S 7/481

(52) U.S. Cl. CPC G02B 19/0047; G02B 26/0816; G02B 27/30; G02B 27/126; G02B 26/10; B60T 7/22; B60Q 9/008; G01S 17/931; G01S 7/4817

(57) ABSTRACT

An optical apparatus includes a first optical system configured to condense illumination light from a light source, a dividing unit configured to divide the illumination light from the first optical system into a plurality of illumination lights in a plurality of areas, a deflecting unit configured to scan an object by deflecting the plurality of illumination lights, and a light guide unit configured to guide the plurality of illumination lights from the dividing unit to the deflecting unit.

### BACKGROUND

### Technical Field

The disclosure relates to an optical apparatus that detects an object by receiving reflected light from the illuminated object.

### Description of the Related Art

One known method for measuring a distance to the object is LiDAR (Light Detection and Ranging) which calculates the distance based on a period necessary to receive the reflected light from the illuminated object or a phase of the reflected light. Japanese Patent No. 4476599 discloses a configuration that measures the position and distance of the object based on an angle of a deflecting unit (drive mirror) and a signal obtained from a light receiving element when the light receiving element receives the reflected light from the object. Japanese Patent Laid-Open No. 2020-126065 discloses a configuration that introduces illumination lights from a plurality of illumination units to the deflecting unit at different angles.

In the configurations disclosed in Japanese Patent No. 4476599 and Japanese Patent Laid-Open No. 2020-126065, as a light amount of the illumination light is made larger, the reflected light from the object is intensified and a longer distance can be measured. A light emitting surface of a laser having a large light amount is often long in a single direction, and in this case, a ratio of an area other than an area that receives the reflected light in the light receiving area of the light receiving element increases and thus a signal to noise (SN) ratio of the signal obtained from the light receiving element lowers. In addition, in a case where a plurality of light sources are used as disclosed in Japanese Patent Laid-Open No. 2020-126065, a power consumption amount increases.

### SUMMARY

The disclosure provides an optical apparatus that can efficiently detect a distant object.

An optical apparatus according to one aspect of the disclosure includes a first optical system configured to condense illumination light from a light source, a dividing unit configured to divide the illumination light from the first optical system into a plurality of illumination lights in a plurality of areas, a deflecting unit configured to scan an object by deflecting the plurality of illumination lights, and a light guide unit configured to guide the plurality of illumination lights from the dividing unit to the deflecting unit.

An in-vehicle system according to another aspect of the disclosure includes the above optical apparatus and determines whether a collision is likely to occur between a vehicle and the object based on distance information on the object acquired by the optical apparatus. A moving apparatus according to another aspect of the disclosure includes the above optical apparatus and can move while holding the optical apparatus.

Further features of the disclosure will become apparent from the following description of exemplary embodiments with reference to the attached drawings.

### BRIEF DESCRIPTION OF THE DRAWINGS

FIG. 1 is a schematic view of an optical apparatus according to a first embodiment.

FIG. 2 illustrates an example of a configuration of a light source.

FIG. 3 is a schematic diagram of a branching unit.

FIGS. 4A and 4B illustrate an illumination optical path and a light receiving optical path of the optical apparatus.

FIG. 5 illustrates a relationship between a conjugate image of a light emitting surface of the light source and an edge portion of a light-beam (luminous-flux) separating unit.

FIG. 6 illustrates an angle of view that can be scanned by a scanning unit.

FIGS. 7A and 7B illustrate a positional relationship between a light receiving area and imaged light.

FIGS. 8A and 8B illustrate a positional relationship between an imaging position of the light source and the light-beam separating unit.

FIG. 9 illustrates a light ray emitted from the light source and an arrangement range of the light-beam separating unit.

FIG. 10 is a schematic view of a shaping optical system according to a second embodiment.

FIG. 11 is a schematic view of an optical apparatus of the second embodiment.

FIG. 12 illustrates a relationship among angles of view of three light beams.

FIG. 13 is a configuration diagram of an in-vehicle system according to this embodiment.

FIG. 14 is a schematic view of a vehicle (moving apparatus) according to this embodiment.

FIG. 15 is a flowchart showing an operation example of an in-vehicle system according to this embodiment.

### DESCRIPTION OF THE EMBODIMENTS

Referring now to the accompanying drawings, a detailed description will be given of embodiments according to the disclosure. Corresponding elements in respective figures will be designated by the same reference numerals, and a duplicate description thereof will be omitted.

An optical apparatus (distance measuring apparatus) using LiDAR includes an illumination system that illuminates an object and a light receiving system that receives reflected or scattered light from the object. LiDAR can be classified into a coaxial system in which some of optical axes of the illumination system and the light receiving system coincide with each other, and a noncoaxial system in which these optical axes do not coincide with each other. The optical apparatus according to this embodiment is suitable for the coaxial system of LiDAR, but is applicable to the noncoaxial system of LiDAR.

### First Embodiment

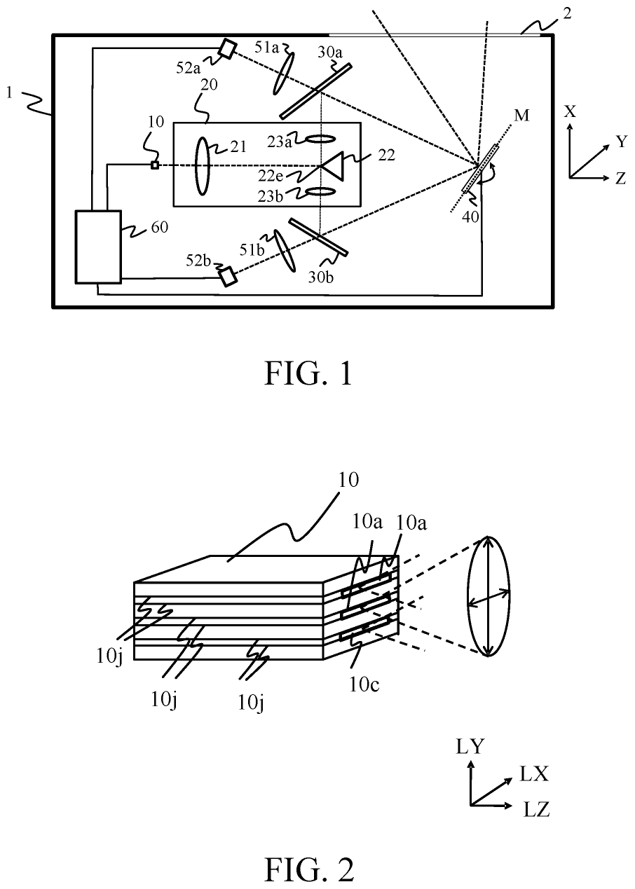

FIG. 1 is a schematic view of an optical apparatus 1 according to this embodiment. The optical apparatus 1 includes a light source 10, a shaping optical system 20, branching units (light guide units) 30a and 30b, a scanning unit (deflecting unit) 40, imaging lenses 51a and 51b, light receiving elements 52a and 52b, and a control unit 60.

The light source 10 is, for example, a multi-stack multi-mode LD (laser diode) that emits high-power light. FIG. 2 illustrates an example of a configuration of the light source 10. The light source 10 emits light having different divergence angles on an LX-axis and an LY-axis orthogonal to the LX-axis from a surface having a radiation angle distribution in which a plurality of ellipses are arranged. In FIG. 2, a divergence angle in a direction orthogonal to a PN junction surface 10j (LY-axis direction) is large, and a divergence angle in a horizontal direction (LX-axis direction) is small. In the multi-stack light source, light emitting surfaces having different aspect ratios are often emitted. In FIG. 2, light emitting surfaces 10a, 10b, and 10c are rectangles that are long in a single direction. Each of the light emitting surfaces 10a, 10b, and 10c has a size of 10 μm×200 μm.

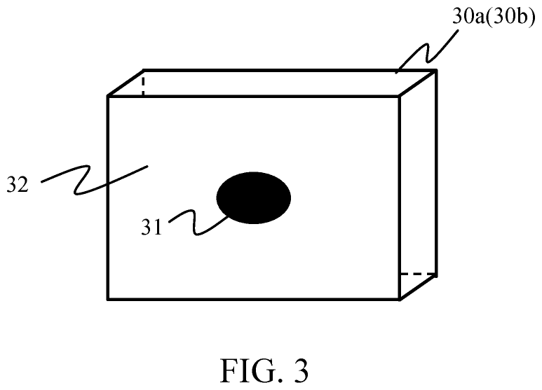

The shaping optical system 20 shapes the light from the light source 10 into predetermined divergent light. The branching units 30a and 30b are disposed between the light source 10 and the scanning unit 40, and branch an illumination optical path for illuminating the object of the optical apparatus 1 and a light receiving optical path for receiving the reflected light from the object. More specifically, the branching units 30a and 30b guide the illumination light from the light source 10 to the scanning unit 40 and guide the reflected light from the scanning unit 40 to the light receiving elements 52a and 52b. As illustrated in FIG. 3, the branching units 30a and 30b have a reflection unit 31 as a surface having a high reflectance and a transmission unit 32 as a surface having a low reflectance. The scanning unit 40 is, for example, a MEMS mirror that swings around a Y-axis and an M-axis orthogonal to the Y-axis. The imaging lenses 51a and 51b image the reflected lights from the object. The light receiving elements 52a and 52b receive the imaging lights from the imaging lenses 51a and 51b, respectively. The control unit 60 controls the light source 10, the scanning unit 40, and the light receiving elements 52a and 52b. The control unit 60 processes signals output from the light receiving elements 52a and 52b.

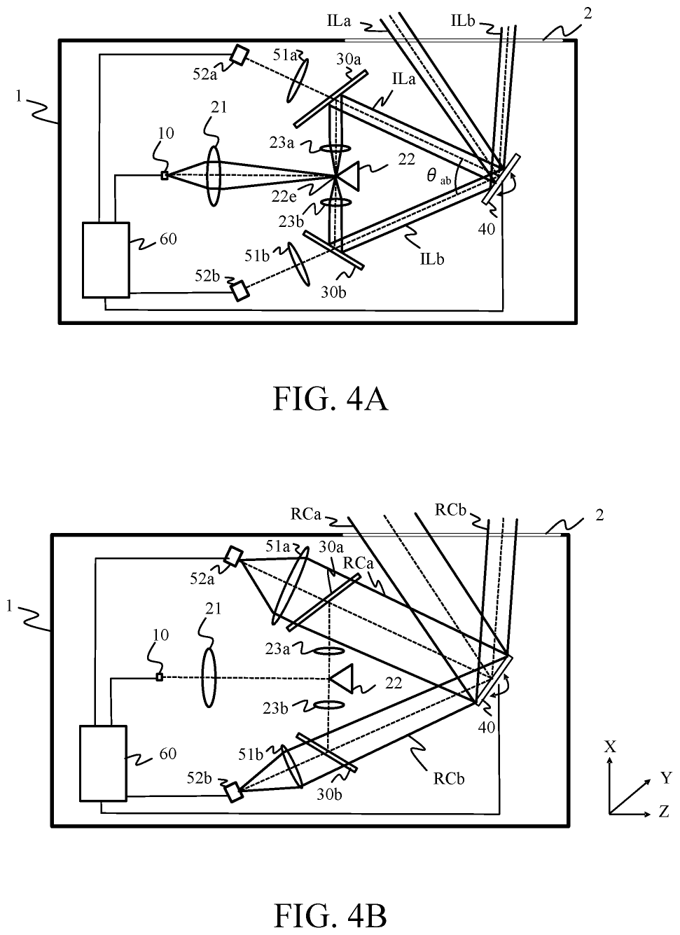

A description will now be given of the operation of the optical apparatus 1. FIGS. 4A and 4B illustrate an illumination optical path and a light receiving optical path. FIG. 4A illustrates that a light beam from the light source 10 is shaped by the shaping optical system 20, guided to the scanning unit 40, and emitted as light beams ILa and ILb from an opening window 2 of the optical apparatus 1.

The shaping optical system 20 includes, in order from the side of the light source 10 to the object side, an imaging optical system (condenser optical system) 21, a light-beam separating unit (dividing unit) 22, and light guide optical systems 23a and 23b. The imaging optical system 21 condenses the illumination light from the light source 10 and forms an image on the light emitting surface of the light source 10. In this embodiment, the imaging optical system 21 magnifies the light emitting surface of the light source 10 at a magnification β. For example, assume that the light emitting surface has a size of a×b (a>b). Then, the imaging optical system 21 forms an image with a size of |β|×(a×b) on a conjugate surface. The light-beam separating unit 22 separates (or divides) the illumination light from the imaging optical system 21 into a plurality of illumination lights in a plurality of areas (divides the illumination for each area) and guides the illumination light as a plurality of lights (light beams) to the branching units 30a and 30b. In this embodiment, the light-beam separating unit 22 includes a prism having a plurality of reflective surfaces, each of which reflects illumination light from the imaging optical system 21. In this embodiment, the plurality of reflective surfaces are integrally formed, but each of them may be provided to different components. An edge portion 22e is a boundary between the plurality of reflective surfaces, and the illumination light from the imaging optical system 21 enters the edge portion 22e. A conjugate image 10i of the light emitting surface of the light source 10 imaged by the imaging optical system 21 is separated into light beams ILa and ILb traveling in different directions by the edge portion 22e.

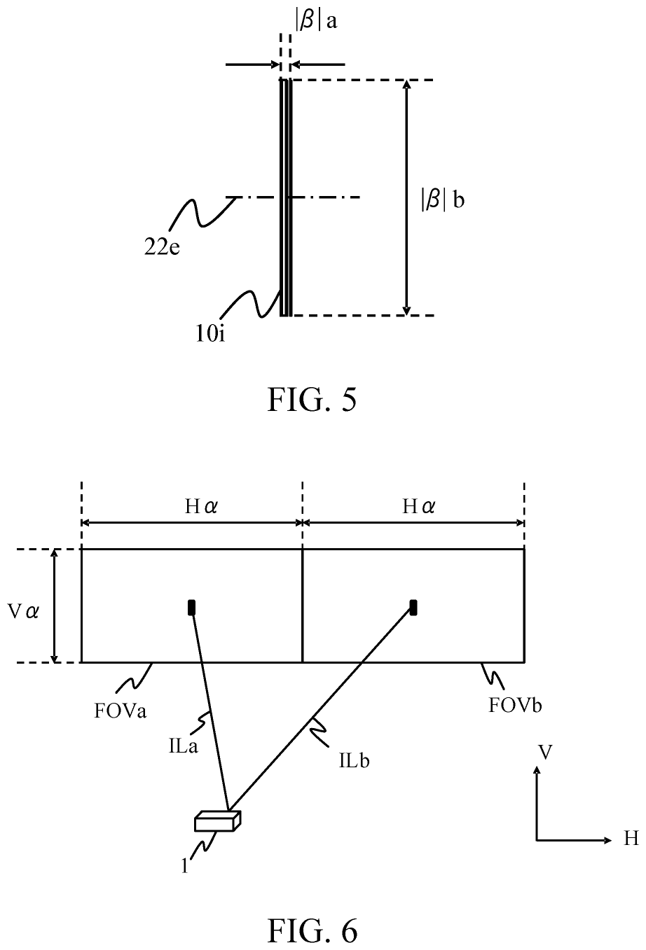

FIG. 5 illustrates a relationship between the conjugate image 10i of the light emitting surface of the light source 10 and the edge portion 22e of the light-beam separating unit 22. In a case where the edge portion 22e is disposed at the center of the conjugate image 10i, each light beam is separated into a size of |β|×(a×b)/2, and guided as divergent light to a subsequent optical system.

The light guide optical systems 23a and 23b perform collimation that converts each of the plurality of light beams separated by the light-beam separating unit 22 into parallel light so that it does not widely spread at a distant location. The parallel light here is not limited to strictly parallel light, but includes approximately parallel light such as weakly convergent or divergent light. Each light beam is reflected by a part of the reflective surfaces of the branching units 30a and 30b, but the light beams ILa and ILb reflected by the scanning unit 40 illuminate the object in different directions when angles of the light beams ILa and ILb reflected by the scanning unit 40 are made different from each other. That is, if no shaping optical system 20 is provided, a single light beam irradiates the object and a scanning range is determined only by the deflection angle of the scanning unit 40. On the other hand, with the shaping optical system 20, a plurality of light beams irradiate the object, and a wider range can be scanned by making different the angles of the light beams reflected by the scanning unit 40 from each other.

The scanning unit 40 has two scanning axes and two-dimensionally scans the external world. FIG. 6 illustrates an angle of view scannable by the scanning unit 40. Assume that the scanning angle by the scanning unit 40 is an angle Ha in a horizontal (H-axis) direction and an angle Vα in a vertical (V-axis) direction. In a case where the angle θab formed between the light beams ILa and ILb is the angle Ha, angles of view FOVa and FOVb scanned by the light beams ILa and ILb have the angle Ha in the H-axis direction and the angle Vα in the V-axis direction. In a case where the light beams ILa and ILb do not vertically enter the scanning unit 40, the scanning range does not draw a rectangular angle of view unlike FIG. 6 and is distorted, the angle of view θab may be set so that the angles of view FOVa and FOVb has an overlap.

A description will be given of the divergence angles of the light beams ILa and ILb. The divergence angle θ of each light beam is expressed by the following expression from the Lagrange-Helmholtz amount:

θ=tan⁻¹(|β|×a/4f)×2

where f is a focal length of the light guide optical system 23.

If a collimator lens is provided as disclosed in Japanese Patent No. 4476599 and Japanese Patent Application Laid-Open No. 2020-126065 instead of the shaping optical system 20, a divergence angle θ′ is expressed by the following expression from the Lagrange-Helmholtz amount:

θ=tan⁻¹(a×2f′)×2

where f′ is a focal length of the collimator lens.

That is, the divergence angle θ can be made equal to or less than the divergence angle θ′ by setting |β|/2f≤1/f′.

FIG. 4B illustrates that reflected lights RCa and RCb from the object are guided from the scanning unit 40 to the branching units 30a and 30b, passed through the transmission units 32 of the branching units 30a and 30b, imaged by the imaging lenses 51a and 51b, and received by the light receiving elements 52a and 52b.

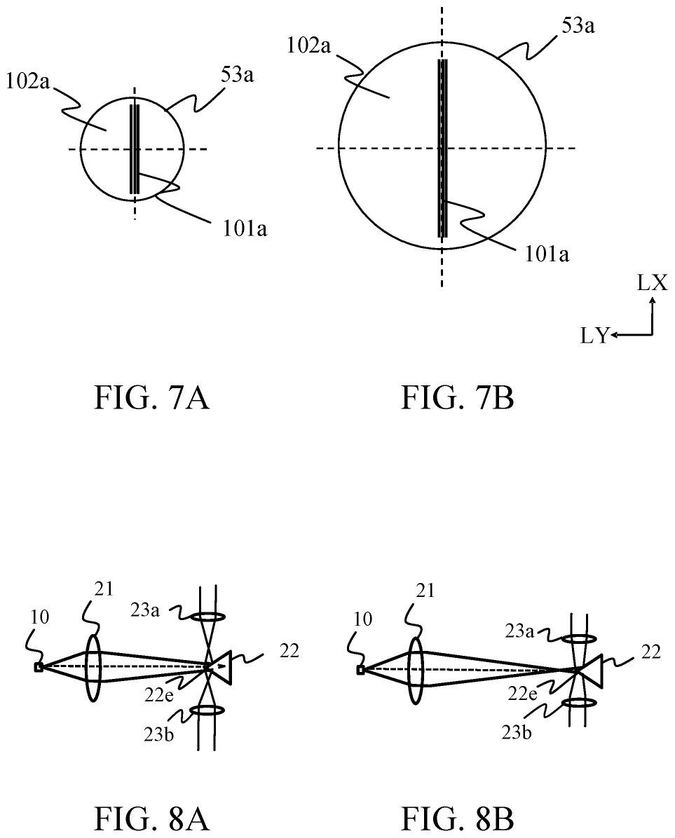

FIGS. 7A and 7B illustrate a positional relationship between the light receiving area and the imaged light. FIG. 7A illustrates a positional relationship among the light receiving area 53a in the light receiving element 52a, ideal imaged light 101a, and an area 102a which imaged light 101a in the light receiving area 53a does not enter where the shaping optical system 20 is provided and the light source image is separately illuminated. FIG. 7B illustrates a positional relationship among the light receiving area 53a, the imaged light 101a, and the area 102a where no shaping optical system 20 is provided and the light source image is illuminated without being separated. An intersection of two dotted lines is the center of the light receiving area 53.

The object is illuminated with illumination light that is long in the LX-axis direction, and the light receiving area 53a wholly covers the long illumination area. By separating the light source image into a plurality of light source images at the shaping optical system 20, the illumination area can be shortened and the light receiving area can also be shortened. With the shaping optical system 20, the size of the light receiving area can be quartered. The external light amount is also quartered, but a received light amount reflected from the object is only halved, and a ratio of an external light amount to the received light amount is relatively halved. Thus, even if the illumination light amount is halved, the external light is further halved and thus the SN ratio of the received signal is improved and distance measurement at a longer distance is available. The light source 10 can make the power of the emitted light twice as high as the conventional one. The longer the light source 10 is, the higher the power of the emitted light becomes, but the power of the emitted light per unit area does not significantly change. In a case where the light from the light source 10 having the light emitting surface that is long in the single direction is separated and used for illumination as in this embodiment, even if the power of the emitted light of the light source 10 is high, power of each light beam emitted from the optical apparatus 1 can be suppressed within the eye-safe range.

Hence, the optical apparatus 1 according to this embodiment separates the light source 10 and thereby improves a measurable distance while improving the resolution in comparison with a case where no shaping optical system 20 is provided.

In this embodiment, the light-beam separating unit 22 includes the reflective surfaces and forms a reflection optical path, but this embodiment may use the transmission light by utilizing a transmission surface.

As long as the divergence angle of each light beam becomes smaller while the number of optical paths is increased, the light-beam separating unit 22 does not have to perfectly coincide with the conjugate surface of the light source 10 and may be disposed at a position before or after the position of the conjugate image 10i formed by the imaging optical system 21. For example, FIG. 8A illustrates the light-beam separating unit 22 disposed at the position before the position of the conjugate image 10i formed by the imaging optical system 21. The divergence of the emitted light beams ILa and ILb at this time is larger than that where the light-beam separating unit 22 is disposed at the position of the conjugate image 10i formed by the light-beam separating unit 22. However, the degree of divergence of each light beam is smaller than that of the case where no light-beam separating unit 22 is provided.

FIG. 8B illustrates the light-beam separating unit 22 disposed at the position after the position of the conjugate image 10i formed by the imaging optical system 21, but an effect is acquired similarly to the case where the light-beam separating unit 22 is disposed at the position before the position of the conjugate image 10i. However, if the light-beam separating unit 22 is separated from the position of the conjugate image 10i so that the light beam diameter is larger than that of the imaging optical system 21, the effect of separating the light source image is almost eliminated.

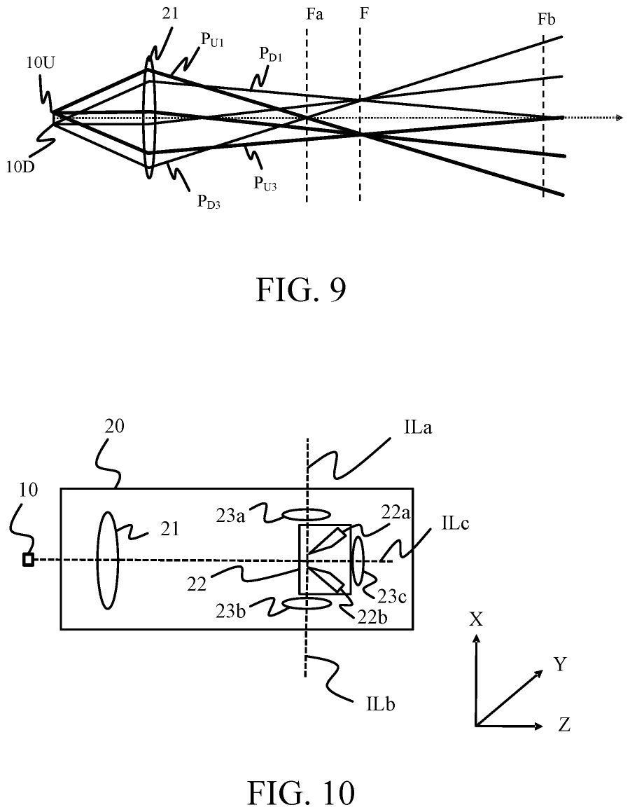

FIG. 9 illustrates a relationship between the light beam emitted from the light source 10 and the arrangement of the light-beam separating unit 22. In FIG. 9, when viewed from the longitudinal direction of the light emitting surface of the light source 10, reference numeral 10U is set to one end portion (first end portion) of the two long sides of the light emitting surface of the light source 10, and reference numeral 10D is set to the other end portion (second end portion), and light rays from these end portions pass through the imaging optical system 21 and form an image at an imaging position F. In FIG. 9, P_{U1} and P_{D1} are top lines, and P_{U3} and P_{D3} are bottom lines. A position Fa is a position where the light rays P_{U1} and P_{D3} intersect each other, and a position Fb is a position where the light rays P_{D1} and P_{U3} intersect each other. The light rays from the end portions 10U and 10D are separated between the positions Fa and Fb. If the light-beam separating unit 22 is disposed between the positions Fa and Fb, the length in the longitudinal direction can be made shorter in comparison with the length in the lateral direction of the light emitting surfaces 10a to 10c in the separated light source image. The top and bottom lines depend on the focal length of the optical system, the optical configuration, an unillustrated aperture stop, etc., but it is important to dispose the light-beam separating unit 22 at a position for separating the light from the longer end portion of the light emitting surface.

An unillustrated magnification-varying optical system may be disposed on the light exit side of the scanning unit 40. The magnification-varying optical system has no refractive power in the entire system, guides the illumination light from the scanning unit 40 to the object, and guides the reflected light from the object to the scanning unit 40. In a case where the magnification-varying optical system is provided, there may be no stray light within the angle of view. For example, in the magnification-varying optical system, the optical axis may be eccentric from the center of the scanning unit 40.

### Second Embodiment

A basic configuration of an optical apparatus according to this embodiment is the same as that of the optical apparatus 1 according to the first embodiment. This embodiment will discuss a configuration different from that of the first embodiment, and a description of the common configuration will be omitted.

This embodiment is different from the first embodiment in that the configuration of the light-beam separating unit 22 is different and the number of light beam separations is three. In addition, when the reflected light is received, a focal length of the imaging lens for the central angle-of-view light beam is shorter than that of the other angle-of-view light beam, and the size of the reflected imaging light with respect to the light-receiving area is small. FIG. 10 is a schematic view of a shaping optical system 20 according to this embodiment.

In this embodiment, the light-beam separating unit 22 includes a plurality of mirrors 22a and 22b, each of which includes a plurality of reflective surfaces for reflecting the illumination light from the imaging optical system 21. The light-beam separating unit 22 includes a mirror 22FM, which will be described below. The mirrors 22a and 22b are spaced from each other. At least one of the mirrors 22a and 22b includes an edge portion which the illumination light from the imaging optical system 21 enters. This embodiment divides the magnification-varying image of the light source 10 formed by the imaging optical system 21 into three areas, i.e., two mirrors and a space between them, and forms light beams reflected by the mirrors 22a and 22b and a light beam transmitting between the mirrors 22a and 22b. Thereby, the light source image is separated into three, and the light beams ILa, ILb, and ILc are formed.

The light beams reflected by the mirrors 22a and 22b follow the same illumination optical paths and light receiving optical paths as those of the first embodiment, but in a case where the light emitting surface of the light source 10 is as large as that of the first embodiment, an aspect ratio of the divergence angle of the light beam is smaller than that of the first embodiment due to the three branches. However, it is unnecessary to equally branch the light, and the length of the imaging light may be changed relative to the non-reflected optical path according to the desired measurement distance at the corresponding angle of view. For example, the imaged light of the light beam that is not reflected may be longer than that of the light beam that is reflected, and as a result, the emitted light amount can be increased.

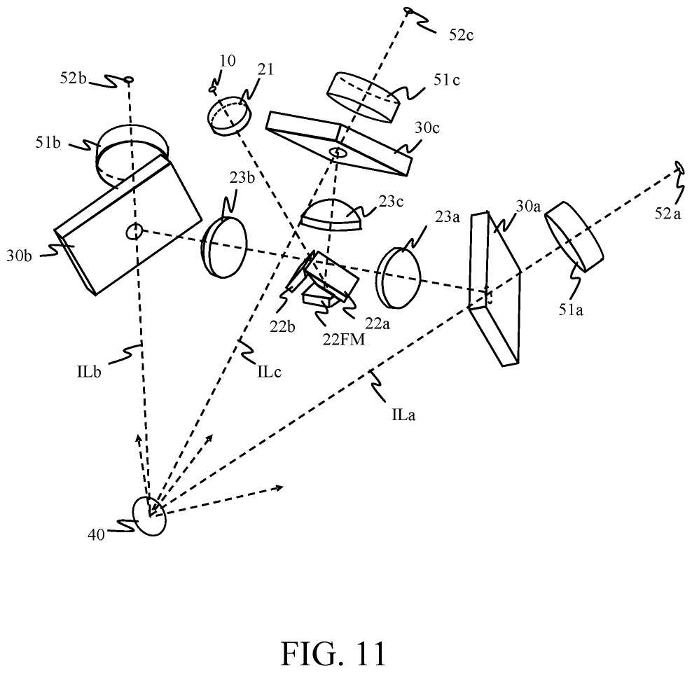

FIG. 11 is a schematic view of the optical apparatus 1 according to this embodiment, and illustrates a configuration for guiding the light beams ILa, ILb, and ILc to the scanning unit 40 using a folding mirror or the like. The light beams ILa and ILb are reflected by the mirrors 22a and 22b, pass through the light guide optical systems 23a and 23b, are reflected by the branching units 30a and 30b, and are guided to the scanning unit 40. The reflected lights from the scanning unit 40 pass through the transmission units 32 of the branching units 30a and 30b, are imaged by the imaging lenses 51a and 51b, and are received by the light receiving elements 52a and 52b. On the other hand, the light beam ILc passes through a space between the mirrors 22a and 22b, is reflected by the mirror 22FM, passes through a light guide optical system 23c, is reflected by a branching unit 30c, and is guided to the scanning unit 40. The reflected light from the scanning unit 40 passes through the transmission unit 32 of the branching unit 30c, is imaged by the imaging lens 51c, and is received by a light receiving element 52c. Due to this configuration, a single light source 10 can form three light beams ILa, ILb, and ILc, and each light beam can measure different angles of view.

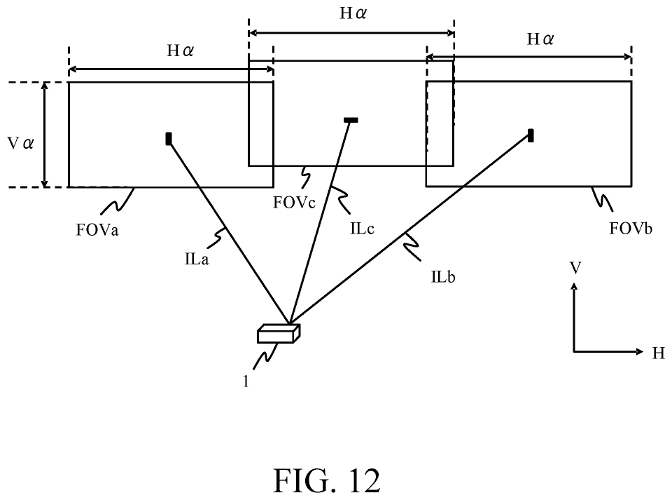

FIG. 12 illustrates a relationship among the angles of view of the light beams ILa, ILb, and ILc. Angles of view FOVa, FOVb, and FOVc measured by the light beams ILa, ILb, and ILc are areas in which the angles of view are represented by angles Hα and Vα, and each contains a small overlap amount. Since the light beam ILc has a different guide angle to the scanning unit 40 from the light beams ILa and ILb, the angle of view in the V-axis direction is different from the angles of view FOVa and FOVb. The angles of view FOVa, FOVb, and FOVc can be set to the angles of view that can be measured as a whole by setting the incident angles of the light beams ILa, ILb, and ILc on the scanning unit 40 according to the situation to be measured.

If the light transmitting amount through the light-beam separating unit 22 is increased, the optical apparatus 1 according to this embodiment can distribute the power of the emitting light of the light source 10 to the central angle of view FOVc, and can make longer the measurable distance of the central angle of view FOVc than that of each of the side angles of view FOVa and FOVb.

As described above, even if the light source 10 has the light emitting surface that is long in a single direction, the configuration according to this embodiment can separate the light into a plurality of light beams at the shaping optical system 20 and can efficiently measure a distant object at a wide angle.

### In-Vehicle System

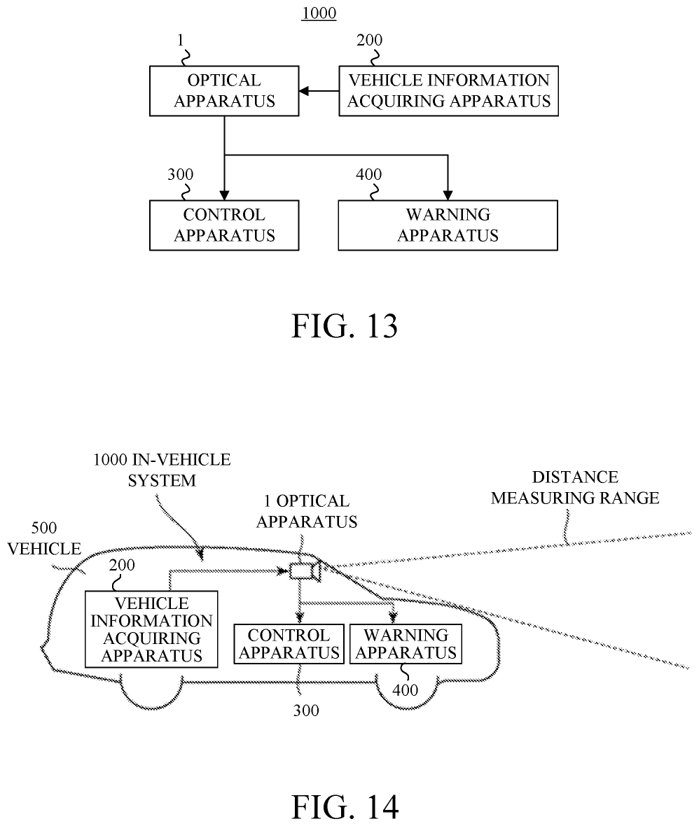

FIG. 13 is a configuration diagram of an optical apparatus 1 according to this embodiment, and an in-vehicle system (driving support apparatus) 1000 having the same. The in-vehicle system 1000 is an apparatus held by a movable moving body (moving apparatus) such as an automobile (vehicle), and configured to support driving (steering) of the vehicle based on distance information on an object such as an obstacle or a pedestrian around the vehicle acquired by the optical apparatus 1. FIG. 14 is a schematic diagram of a vehicle 500 including the in-vehicle system 1000. FIG. 14 illustrates a case where the distance measurement range (detection range) of the optical apparatus 100 is set to the front of the vehicle 500, but the distance measurement range may be set to the rear or side of the vehicle 500.

As illustrated in FIG. 13, the in-vehicle system 1000 includes the optical apparatus 1, a vehicle information acquiring apparatus 200, a control apparatus (ECU: electronic control unit) 300, and a warning apparatus (warning unit) 400. In the in-vehicle system 1000, the control unit 60 included in the optical apparatus 1 has functions of a distance acquiring unit (acquiring unit) and a collision determining unit (determining unit). However, if necessary, the in-vehicle system 1000 may include a distance acquiring unit and a collision determining unit separate from the control unit 60, or each component may be provided outside of the optical apparatus 1 (for example, inside the vehicle 500). Alternatively, the control apparatus 300 may be used as the control unit 60.

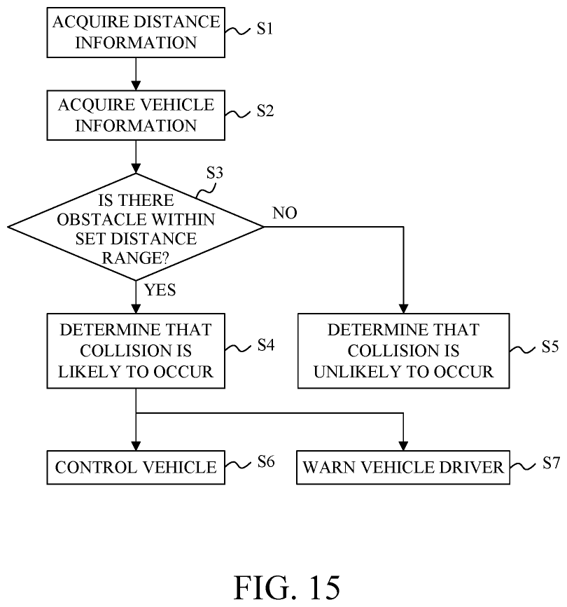

FIG. 15 is a flowchart showing an operation example of the in-vehicle system 1000 according to this embodiment. A description will now be given of the operation of the in-vehicle system 1000 with reference to this flowchart.

First, in step S1, the light source 10 of the optical apparatus 1 illuminates the object around the vehicle, and the control unit 60 acquires the distance information on object OBJ based on the signal output from the light receiving element by receiving the reflected light from the object. In step S2, the vehicle information acquiring apparatus 200 acquires vehicle information including the speed, yaw rate, steering angle of the vehicle, and the like. Then, in step S3, the control unit 60 determines whether the distance to the object OBJ is included within a preset distance range using the distance information acquired in step S1 and the vehicle information acquired in step S2.

This configuration can determine whether or not the object exists within the set distance range around the vehicle, and determine whether a collision is likely to occur between the vehicle and the object. Steps S1 and S2 may be performed in the reverse order of the above order or in parallel with each other. The control unit 60 determines that the collision is likely to occur in a case where the object exists within the set distance (step S4) and determines that the collision is unlikely to occur in a case where the object does not exist within the set distance (step S5).

Next, in the case where the control unit 60 determines that the collision is likely to occur, the control unit 60 notifies (transmits) the determination result to the control apparatus 300 and the warning apparatus 400. At this time, the control apparatus 300 controls the vehicle based on the determination result of the control unit 60 (step S6), and the warning apparatus 400 warns the user (driver) of the vehicle based on the determination result of the control unit 60 (step S7). The determination result may be notified to at least one of the control apparatus 300 and the warning apparatus 400.

The control apparatus 300 can control the movement of the vehicle by outputting a control signal to a driving unit (engine, motor, etc.) of the vehicle. For example, in the vehicle, control can be made such as applying a brake, releasing an accelerator, turning a steering wheel, generating a control signal for generating a braking force on each wheel, and suppressing the output of the engine or motor. The warning apparatus 400 warns the vehicle driver, for example, by issuing a warning sound, displaying warning information on the screen of a car navigation system, or vibrating a seat belt or steering.

Thus, the in-vehicle system 1000 according to this embodiment can detect the object and measure the distance by the above processing, and avoid the collision between the vehicle and the object. In particular, applying the optical apparatus according to each of the embodiments to the in-vehicle system 1000 can realize high distance measuring accuracy, so that object detection and collision determination can be performed with high accuracy.

This embodiment applies the in-vehicle system 1000 to the driving support (collision damage mitigation), but the in-vehicle system 1000 is not limited to this example and is applicable to cruise control (including adaptive cruise control) and automatic driving. The in-vehicle system 1000 is applicable not only to a vehicle such as an automobile but also to a moving body such as a ship, an aircraft, or an industrial robot. It can be applied not only to moving objects but also to various devices that utilize object recognition such as intelligent transportation systems (ITS) and monitoring systems.

The in-vehicle system 1000 and the moving apparatus may include a notification apparatus (notifying unit) for notifying the manufacturer of the in-vehicle system, the seller (dealer) of the moving apparatus, or the like of any collisions between the moving apparatus and the obstacle. For example, the notification apparatus may use an apparatus that transmits information (collision information) on the collision between the moving apparatus and the obstacle to a preset external notification destination by e-mail or the like.

Thus, the configuration for automatically notifying the collision information through the notification apparatus can promote processing such as inspection and repair after the collision. The notification destination of the collision information may be an insurance company, a medical institution, the police, or another arbitrary destination set by the user. The notification apparatus may notify the notification destination of not only the collision information but also the failure information on each component and consumption information on consumables. The presence or absence of the collision may be detected based on the distance information acquired by the output from the above light receiving unit or by another detector (sensor).

Each embodiment can provide an optical apparatus that can provide efficiently detect a distant object.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-176063, filed on Oct. 28, 2021, which is hereby incorporated by reference herein in its entirety.

What is claimed is:

1. An optical apparatus comprising:
a first optical system configured to condense illumination light from a light source;
a dividing unit configured to divide the illumination light from the first optical system into a plurality of illumination lights in a plurality of areas;
a deflecting unit configured to scan an object by deflecting the plurality of illumination lights; and
a light guide unit configured to guide the plurality of illumination lights from the dividing unit to the deflecting unit.

2. The optical apparatus according to claim 1, further comprising a second optical system configured to guide the plurality of lights from the dividing unit to the light guide unit.

3. The optical apparatus according to claim 2, wherein the second optical system converts each of the plurality of lights into parallel light.

4. The optical apparatus according to claim 1, wherein the deflecting unit deflects a plurality of reflected lights from the object, and the light guide unit guides the plurality of reflected lights from the deflecting unit to a light receiving unit.

5. The optical apparatus according to claim 1, wherein a length of a light emitting surface of the light source in a first direction and a length of the light emitting surface of the light source in a second direction orthogonal to the first direction are different from each other, and
wherein when viewed from the first direction, the dividing unit is located between a position in which a top line of light from a first end portion in the second direction of the light emitting surface and a bottom line of light from a second end portion in the second direction of the light emitting surface overlap each other, and a position in which a bottom line of the light from the first end portion and an top line of the light from the second end portion overlap each other.

6. The optical apparatus according to claim 1, wherein the dividing unit includes a plurality of reflective surfaces, each of which reflects the illumination light from the first optical system.

7. The optical apparatus according to claim 6, wherein the plurality of reflective surfaces are integrated with each other.

8. The optical apparatus according to claim 6, wherein a boundary between the plurality of reflective surfaces constitutes an edge portion configured to divide the illumination light into areas.

9. The optical apparatus according to claim 6, wherein the plurality of reflective surfaces include:
first and second reflective surfaces spaced from each other; and
a third reflective surface configured to reflect light that has passed a space between the first and second reflective surfaces.

10. The optical apparatus according to claim 6, wherein the dividing unit includes a prism that includes the plurality of reflective surfaces.

11. The optical apparatus according to claim 6, wherein the dividing unit includes a plurality of mirrors that include the plurality of reflective surfaces.

12. The optical apparatus according to claim 11, wherein at least one of the plurality of mirrors includes an edge portion configured to divide the illumination light into areas.

13. An in-vehicle system comprising an optical apparatus,
wherein the optical apparatus includes:
a first optical system configured to condense illumination light from a light source;
a dividing unit configured to divide the illumination light from the first optical system into a plurality of illumination lights in a plurality of areas;
a deflecting unit configured to scan an object by deflecting the plurality of illumination lights; and
a light guide unit configured to guide the plurality of illumination lights from the dividing unit to the deflecting unit,
wherein the in-vehicle system determines whether a collision is likely to occur between a vehicle and the object based on distance information on the object acquired by the optical apparatus.

14. The in-vehicle system according to claim 13, further comprising a control apparatus configured to output a control signal for generating a braking force in the vehicle in a case where the in-vehicle system determines that the collision is likely to occur between the vehicle and the object.

15. The in-vehicle system according to claim 13, further comprising a warning apparatus configured to warn a user of the vehicle in a case where the in-vehicle system determines that the collision is likely to occur between the vehicle and the object.

16. The in-vehicle system according to claim 13, further comprising a notification apparatus configured to notify information on the collision between the vehicle and the object to outside.

17. A moving apparatus comprising an optical apparatus,
wherein the optical apparatus includes:
a first optical system configured to condense illumination light from a light source;
a dividing unit configured to divide the illumination light from the first optical system into a plurality of illumination lights in a plurality of areas;
a deflecting unit configured to scan an object by deflecting the plurality of illumination lights; and
a light guide unit configured to guide the plurality of illumination lights from the dividing unit to the deflecting unit,
wherein the moving apparatus can move while holding the optical apparatus.

18. The moving apparatus according to claim 17, further comprising a determining unit configured to determine whether a collision with the object is likely to occur based on distance information on the object acquired by the optical apparatus.

19. The moving apparatus according to claim 18, further comprising a control unit configured to output a control signal for controlling movement in a case where the determining unit determines that the collision with the object is likely to occur.

20. The moving apparatus according to claim 18, further comprising a warning unit configured to warn a user of the moving apparatus in a case where the determining unit determines that the collision with the object is likely to occur.
